(19) United States
(12) Patent Application Publication
(10) Pub. No.: US 2008/0316191 A1
(43) Pub. Date: Dec. 25, 2008

(54) DISPLAY CONTROL APPARATUS AND DISPLAY CONTROL METHOD

(75) Inventor: Keiji Adachi, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/139,930

(22) Filed: Jun. 16, 2008

(30) Foreign Application Priority Data
Jun. 22, 2007 (JP) 2007-165310

(51) Int. Cl. G06F 3/038

(52) U.S. Cl. 345/204

(57) ABSTRACT

Playback which allows the user to easily grasp playback contents is implemented by a simple method while shortening the playback time in a display control apparatus capable of sequentially playing back drawn contents. This invention relates to a display control apparatus connected to a display. The display control apparatus includes a first acquisition unit which acquires an operation information table and drawing object information table from a recording device connected to the display, a second acquisition unit which acquires, from a playback method setting table, a playback method for playing back drawn contents on the display by using the operation information table and drawing object information table acquired by the first acquisition unit, and a playback unit which plays back the drawn contents on the display by using the operation information table and drawing object information table based on he acquired playback method.

### BACKGROUND OF THE INVENTION

1. Field of the Invention

The present invention relates to a display control technique for playing back contents drawn in a drawing area for drawing an object.

2. Description of the Related Art

These days, large-screen displays such as a plasma display, rear-projection display, and front projector have prevailed. It has become popular to make a presentation, hold a conference, or give lessons using such a large-screen display.

When holding a conference or giving lessons using a large-screen display, the user uses a fescue or laser pointer as a means for indicating a specific position on the display screen.

Recently, a pointing system with a digitizer for detecting a position (indicated position) indicated by the user on the display screen has been developed, and the use of the pointing system is growing. The pointing system can move the cursor on the display screen in correspondence with a position indicated by the user on the display screen, or activate a tool corresponding to the indicated position to generate a drawing object such as a character or figure on the display screen. The pointing system can also freely edit the generated drawing object.

Generally in the pointing system, a large-screen display is connected to the video output terminal of a display control apparatus such as a personal computer to display data generated by the personal computer on the large-screen display. The digitizer and personal computer are connected by an interface cable, and transmit information on the indicated position via the interface cable.

An application is installed in the personal computer to reflect information on an indicated position input via the interface cable when, for example, moving the cursor or generating a drawing object such as a character or figure.

The pointing system having this configuration can provide a variety of functions on the display screen by installing a multifunctional application.

For example, the pointing system can provide a handwriting input function by directly drawing an image in accordance with the indicated position on the display screen. In this case, the large-screen display is available as an electronic whiteboard.

The pointing system can also provide a playback function by configuring it to, when the drawn contents displayed on the display screen change, record the changed contents together with time data and play back the contents along with the time data. The playback function can play back the drawn contents displayed on the display screen during a conference with the lapse of time of the conference. For example, when the large-screen display is used as an electronic whiteboard, the playback contents can be utilized as the minutes of the conference.

Various proposals have been made for the playback function of playing back changed contents recorded together with time data.

For example, Japanese Patent Laid-Open No. 2004-336289 discloses a snapshot of a whiteboard as a target recorded for playback by the playback function. This method can play back a conference or lessons. Japanese Patent Laid-Open No. 6-205151 discloses a configuration which plays back audio-video information of a conference in accordance with drawn contents.

Another proposal is helpful for improving the user-friendliness of playback using the playback function. For example, functions such as the fast-forward mode and double-speed playback mode in addition to the normal-speed playback mode are proposed to shorten the playback time.

Japanese Patent Laid-Open No. 11-112922 discloses a configuration which analyzes an event point such as a scene change point of an image or a speaker change point of voice from stream data of an input image or voice. According to this reference, when an event point is detected during playback, streams near the event point are played back slowly to allow the user to easily recognize a specific stream.

However, the playback function capable of improving user-friendliness suffers several problems in an application of this function to the pointing system.

The user of the playback function generally uses this playback function when he wants to check not only contents finally drawn on the electronic whiteboard during a conference or lesson, but also the circumstances behind the drawn contents. It is desirable to play back drawn contents by the playback function so that the user can confirm the contents of a conference or lesson from them.

The playback time is desirably as short as possible. The user has met this demand by using fast-forwarding or double-speed playback. However, when fast-forwarding or double-speed playback is used, contents necessary to grasp drawn contents are also played back at high speed. It is, therefore, desirable to switch the playback speed between contents necessary to grasp drawn contents and unnecessary contents.

For this purpose, Japanese Patent Laid-Open No. 11-112922 may also be applied to analyze recorded drawing objects, detect an event point, and slowly play back streams near the event point. However, this method requires the analysis of recorded drawing objects and complicates processing.

### SUMMARY OF THE INVENTION

The present invention has been made to overcome the conventional drawbacks, and has as its object to implement, by a simple method, playback which allows the user to easily grasp drawn contents while shortening the playback time in a display control apparatus capable of sequentially playing back drawn contents.

A display control apparatus according to the present invention comprises the following configuration. That is, a display control apparatus connected to a display, the apparatus comprising:

a first acquisition unit configured to acquire information on changed contents from a recording device which is connected to the display and records changed contents when drawn contents change in a drawing area on the display;

a second acquisition unit configured to acquire, from a playback method setting table set in correspondence with the changed contents, a playback method for playing back drawn contents on the display by using the information on changed contents acquired by the first acquisition unit; and

a playback unit configured to play back the drawn contents on the display by using the information on changed contents acquired by the first acquisition unit on the basis of the playback method acquired by the second acquisition unit.

The present invention can implement, by a simple method, playback which allows the user to easily grasp contents while shortening the playback time in a display control apparatus capable of sequentially playing back display contents.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the outer arrangement of a conferencing system (display control system) 100 having a display control apparatus according to the first embodiment of the present invention;

FIG. 2 is a block diagram showing the arrangement of a personal computer 120 functioning as the display control apparatus;

FIG. 3 is a view showing an example of a UI displayed on a rear-projection display 110 upon activating the drawing mode of an electronic whiteboard application in the conferencing system 100;

FIG. 4 is a table showing an example of an operation information table 221 generated by recording operation information when the drawn contents in a drawing area 302 change along with a user operation during execution of the drawing mode of an electronic whiteboard application 210;

FIG. 5 is a table showing an example of a drawing object information table 222 which records information on a generated or edited drawing object during execution of the playback mode of the electronic whiteboard application 210 in the conferencing system 100;

FIG. 6 is a table showing an example of a playback method setting table 223 used to specify a playback method during execution of the playback mode of the electronic whiteboard application 210 in the conferencing system 100;

FIG. 7 is a view showing an example of a playback window 700 which plays back the drawn contents of the drawing area 302 during a conference based on the operation information table 221, drawing object information table 222, and playback method setting table 223 in the conferencing system 100;

FIG. 8 is a flowchart showing the sequence of overall processing for playing back a conference in the playback mode of the electronic whiteboard application 210 of the conferencing system 100;

FIG. 9 is a flowchart showing the sequence of conference playback processing executed based on operation information of a designated operation information table; and

FIG. 10 is a view showing the overall configuration of a conferencing system (display control system) using a display control apparatus according to the second embodiment of the present invention.

### DESCRIPTION OF THE EMBODIMENTS

Preferred embodiments of the present invention will now be described in detail in accordance with the accompanying drawings.

### First Embodiment

<1. Outer Arrangement of Conferencing System>

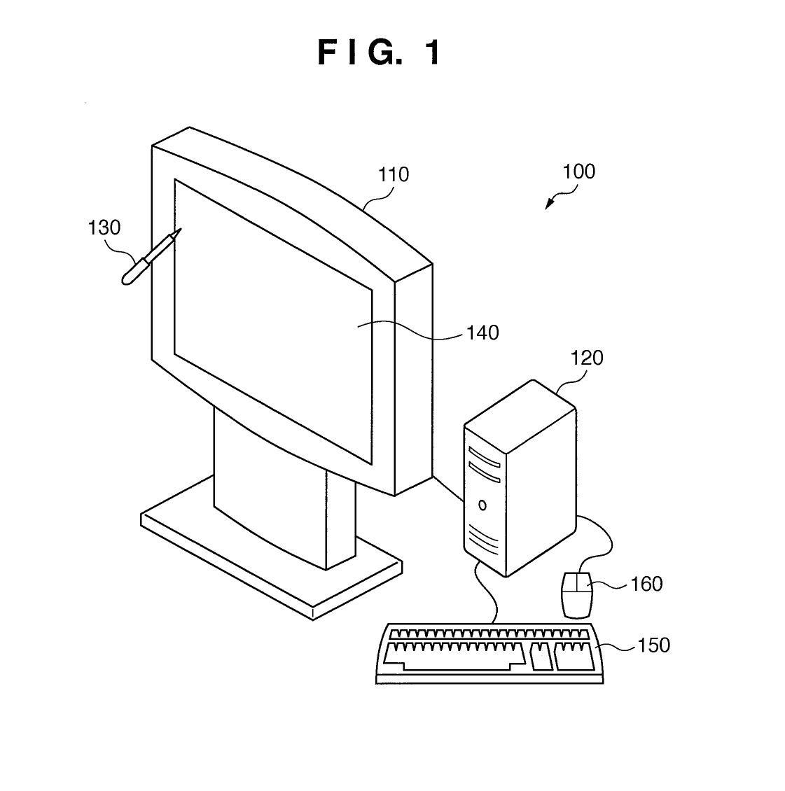

FIG. 1 is a view showing the outer arrangement of a conferencing system (display control system) 100 having a display control apparatus according to the first embodiment of the present invention.

A rear-projection display 110 functions as a display unit which displays, on the display, the execution result of an application (control program) stored in a personal computer (to be described later) to implement an electronic whiteboard.

The rear-projection display 110 incorporates an optical system made up of a light source lamp, color filter, liquid crystal panel, optical lens, mirror, and the like. Light emitted from the light source lamp is split into light beams of three, R, G, and B colors by the color filter or the like, and these light beams hit the liquid crystal panel. Light modulated by the liquid crystal panel is enlarged and projected onto the display screen of the rear-projection display 110 by the optical system. As a result, the execution result of the electronic whiteboard application is displayed on the display screen.

A digitizer module 140 is arranged on the surface of the display screen. The digitizer module 140 emits an infrared ray to scan the surface of the display screen. When an obstacle exists on the display screen, it cuts off the emitted infrared ray, and the reception signal level changes to detect the position and size of the obstacle (information on the designation). By arranging the digitizer module 140, the rear-projection display 110 functions as an input unit which accepts designation from the user to the display screen.

When the user indicates a predetermined position on the display screen with a finger, fescue, or the like, the rear-projection display 110 can detect the position and size.

A digitizer pen 130 is used to indicate a position on the display screen, and functions as a pointing device for indication on the display screen. The digitizer pen 130 has a click determination switch at the tip of the pen, and an erasure switch on its side. When the user presses the erasure switch, the digitizer pen 130 temporarily changes to an erasure mode. If the user indicates a position on the display screen in this mode, a drawing object corresponding to the indicated position is erased.

A personal computer 120 functions as a display control apparatus which controls the display of a drawing object on the rear-projection display 110 on the basis of indication with the digitizer pen 130 or the like. The personal computer 120 is connected to the rear-projection display 110 via an image signal cable and communication cable. The personal computer 120 is also connected to a keyboard 150 and mouse 160 functioning as input devices of the personal computer 120. The operations of various applications in the personal computer 120 are controlled based on inputs from the keyboard 150 and mouse 160.

<2. Arrangement of Display Control Apparatus>

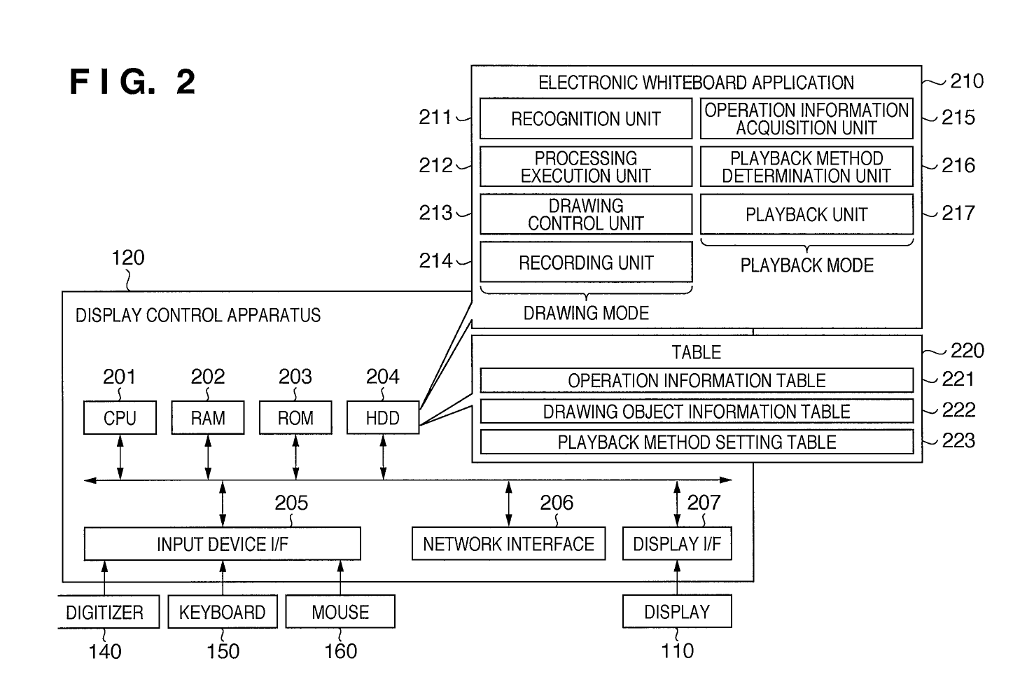

FIG. 2 is a block diagram showing the arrangement of the personal computer 120 functioning as the display control apparatus. The personal computer 120 comprises a CPU 201, RAM 202, ROM 203, HDD 204, input device I/F 205, network interface 206, and display I/F 207.

The input device I/F 205 accepts information on an indicated position output from the digitizer module 140. The input device I/F 205 also accepts instructions from the keyboard 150 and mouse 160 functioning as input devices of the personal computer 120.

An electronic whiteboard application 210 stored in the HDD 204 has a function executed in the drawing mode and a function executed in the playback mode. In the drawing mode, the rear-projection display 110 functions as an electronic whiteboard. In the playback mode, the rear-projection display 110 functions as a playback device.

As functions executed in the drawing mode, the electronic whiteboard application 210 comprises a recognition unit 211, processing execution unit 212, drawing control unit 213, and recording unit 214.

The recognition unit 211 recognizes various operations accepted by the input device I/F 205. More specifically, the recognition unit 211 recognizes a page operation instruction, drawing object generation instruction, edit instruction for a generated drawing object, and the like.

The processing execution unit 212 executes processes corresponding to various operations recognized by the recognition unit 211.

When a drawing object displayed on the rear-projection display 110 changes as a result of processing executed by the processing execution unit 212, the drawing control unit 213 generates a changed drawing object. The drawing control unit 213 outputs the changed drawing object to the rear-projection display 110 via the display I/F 207.

The recording unit 214 records information on the operation (operation information) in an operation information table 221 of the HDD 204 along with various operations recognized by the recognition unit 211. When a drawing object changes upon the operation, the recording unit 214 records information on the drawing object (drawing object information) in a drawing object information table 222.

As functions executed in the playback mode, the electronic whiteboard application 210 comprises an operation information acquisition unit 215, playback method determination unit 216, and playback unit 217.

The operation information acquisition unit 215 acquires an operation information table and drawing object information table designated by the user from operation information tables 221 and drawing object information tables 222 recorded in the HDD 204 for respective conferences.

The playback method determination unit 216 determines, from a playback method setting table 223, a playback method for operation information played back based on the acquired operation information table 221 and drawing object information table 222.

Further, the playback method determination unit 216 executes character processing (determination of whether the drawing object is a character, and character recognition processing) for a drawing object generated by handwriting input.

The playback unit 217 plays back drawn contents on the rear-projection display 110 using operation information according to a playback method determined by the playback method determination unit 216.

The electronic whiteboard application 210, operation information table 221, drawing object information table 222, and playback method setting table 223 are properly loaded into the RAM 202 and executed by the CPU 201 under the control of the CPU 201.

The network interface 206 communicates with the outside.

<3. Arrangement of Display Window>

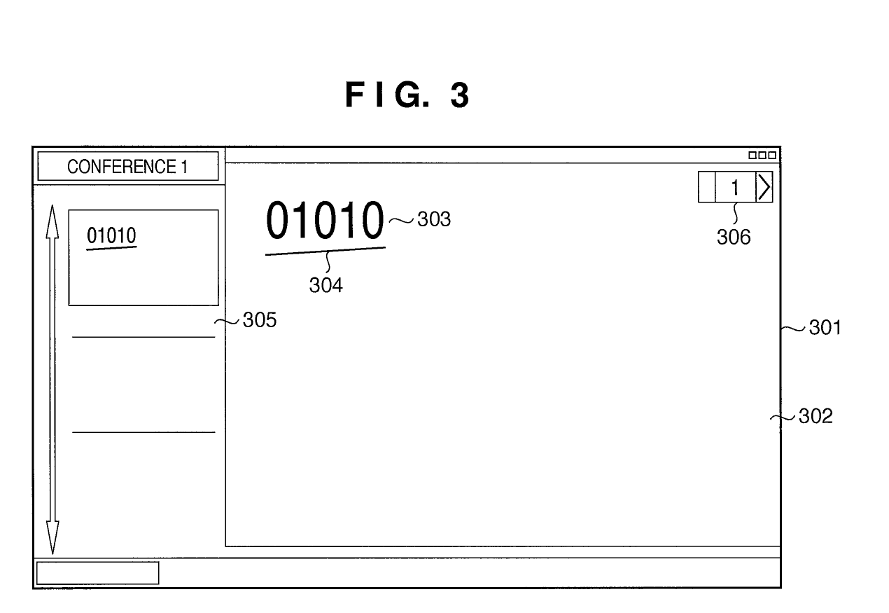

FIG. 3 is a view showing an example of a UI displayed on the display screen of the rear-projection display 110 upon activating the drawing mode of the electronic whiteboard application in the conferencing system 100.

In FIG. 3, a display window 301 has an area (drawing area) 302 where an object can be drawn and input. In the drawing mode, the user can draw a drawing object by a pointing input from the digitizer pen 130. Drawing objects 303 and 304 are examples of such drawing objects.

The drawing object 303 is a character string “01010” input by five handwriting strokes in the handwriting input mode. The drawing object 304 is a straight line input in the tool input mode, and is formed from one stroke. The handwriting input mode and tool input mode are switched from a menu (not shown).

The menu may also be arranged in the display window 301, or displayed as a context menu if a switch attached to the digitizer pen 130 is pressed. Alternatively, a switch dedicated to switching the input mode may also be attached to the digitizer pen 130 to switch the input mode. The tool input mode may also provide a graphic tool for a circle, rectangle, and the like, in addition to a tool for drawing a straight line.

The drawing objects 303 and 304 and the like drawn in the drawing area 302 can also be edited. More specifically, a drawing object is selected, and an item is selected from a menu (not shown) to perform an edit operation such as move, resize, erase, cut, or copy.

A page operation area 305 is provided to operate a page displayed in the drawing area 302. The page operation area 305 displays the thumbnails of pages. By selecting a thumbnail, a page operation such as page switching, move, delete, and new addition is enabled.

A page operation button 306 shows the number of a currently displayed page, and has a page forward/backward button. Even the page operation button 306 can be used to switch the page.

<4. Structure of Operation Information Table 221>

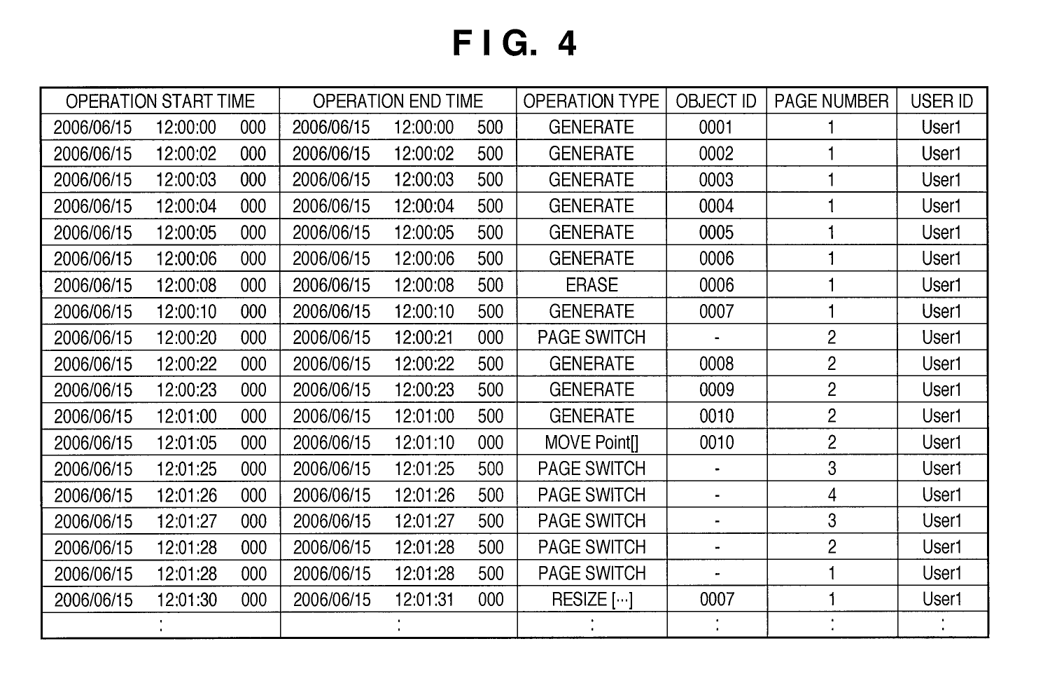

FIG. 4 is a table showing an example of the operation information table 221 generated by sequentially recording pieces of operation information when the drawn contents in the drawing area 302 change along with a user operation during execution of the drawing mode of the electronic whiteboard application 210.

The operation information table 221 is generated for each conference. When the drawn contents in the drawing area 302 change upon a drawing object generation operation, edit operation, page operation, or the like, the recording unit 214 sequentially records the changed contents as operation information in the HDD 204, thereby generating an operation information table.

Each piece of operation information recorded in the operation information table 221 has items such as an operation start time, operation end time, operation type, object ID, page number, and user ID.

The operation start time is the time when the operation starts. The operation end time is the time when the operation ends. The operation type represents the type of operation.

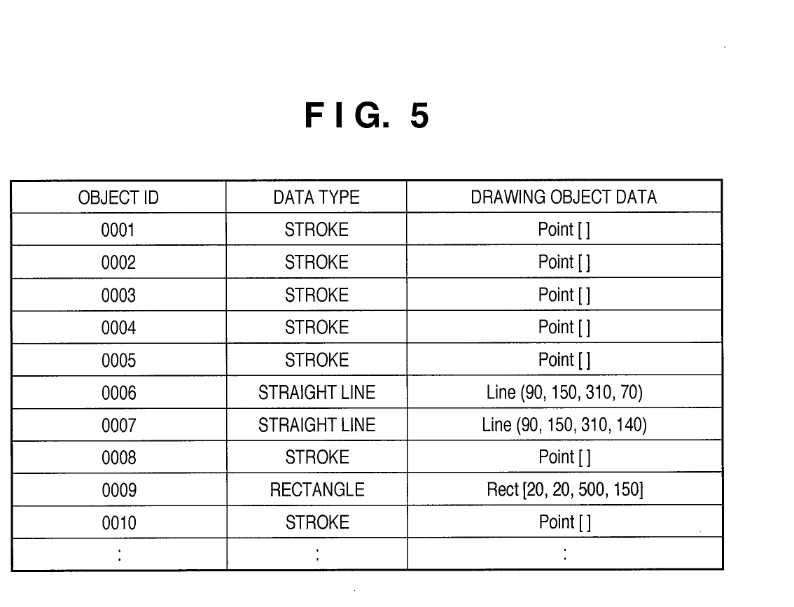

The object ID represents the identifier of a drawing object changed by a user operation, and corresponds to an object ID in a drawing object information table shown in FIG. 5. The page number represents an operated page or a page number to which the current page switches. The user ID represents the ID of the operator.

<5. Structure of Drawing Object Information Table 222>

FIG. 5 is a table showing an example of the drawing object information table 222 which records information on a generated or edited drawing object during execution of the playback mode of the electronic whiteboard application 210 in the conferencing system 100.

An ID is automatically assigned to a drawing object in the drawing area 302. As information on the drawing object, an object ID, data type, and data (drawing object data) necessary to draw a drawing object are recorded in the drawing object information table 222.

The data type is an item representing the type of drawing object, and represents the type of graphic tool such as a stroke, straight line, rectangle, or circle. As the drawing object data, the array of (X,Y) coordinates for a handwritten stroke, the coordinates of initial and end points for a straight line, and upper left and lower right coordinates for a rectangle are saved. In addition, color data, line type data, paint color, and the like may also be saved.

In the first embodiment, the operation information table (FIG. 4) and drawing object information table (FIG. 5) are created for each conference, and recorded in the HDD 204 of the conferencing system 100 during a conference or at the end of the conference. However, the recording destination is not limited to the HDD 204, and these tables may also be recorded in a recording device (not shown) such as a server on the network via the network interface 206.

<6. Structure of Playback Method Setting Table 223>

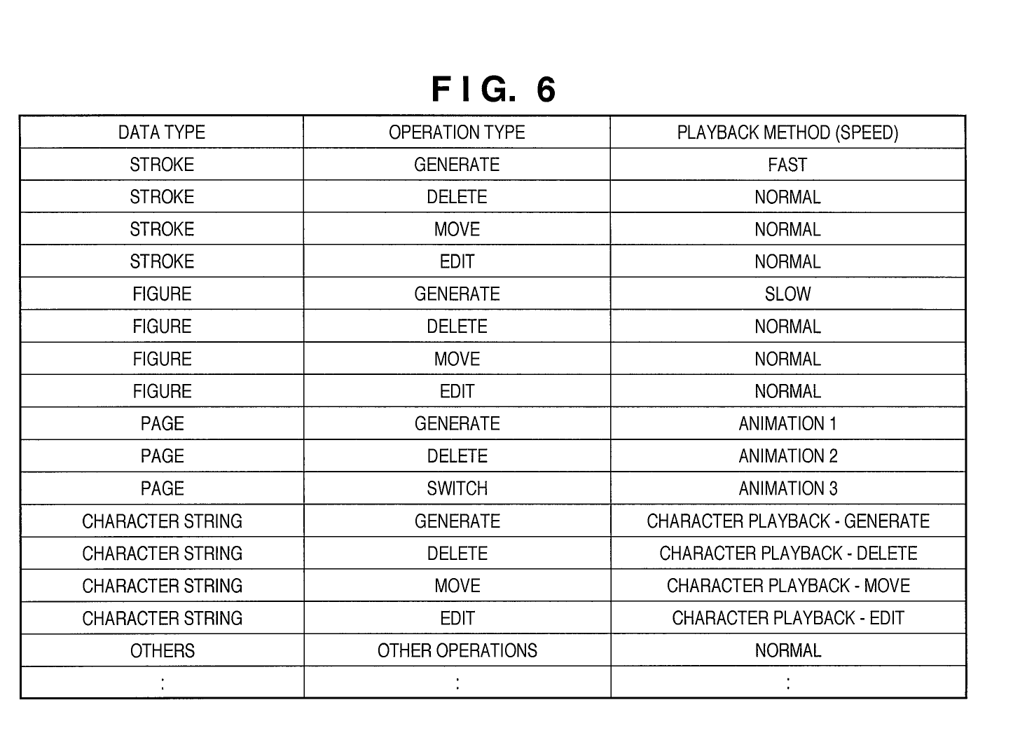

FIG. 6 is a table showing an example of the playback method setting table 223 used to specify a playback method during execution of the playback mode of the electronic whiteboard application 210 in the conferencing system 100.

The playback method setting table 223 includes the data type, operation type, and playback method (speed), and a playback method is set for each combination of the data type and operation type.

In the example of FIG. 6, when the data type is “stroke”, the playback speed of a drawing object played back based on corresponding operation information is set higher than an actual playback speed. This is because a user operation for the data type=stroke is an operation taking a predetermined operation time or more, and if the drawing object is played back at an actual playback speed, the playback time becomes long.

When the data type is “figure”, the playback speed of a drawing object played back based on corresponding operation information is set lower than an actual playback speed. This is because a user operation for the data type=figure is an operation taking a predetermined operation time or less, and if the drawing object is played back at an actual playback speed, the user can hardly grasp the drawn contents.

When the data type is “page”, animation is set as the playback method. Playback of a page operation ends instantaneously, so it is difficult for the user to recognize page switching. To allow the user to recognize page switching, according to the playback method=animation, a page is replaced with an animation display to play back the animation display. Animation data used for the playback method=animation is separately prepared.

The data type=character string is the data type of drawing object determined to be a character or character string as a result of performing character recognition for a plurality of drawing objects of the data type=stroke.

When the data type is “character string”, character playback is set as a playback method. The playback method=character playback is to, when playing back a plurality of drawing objects of the data type=stroke that form a character or character string, draw all the drawing objects at once within a predetermined time. After playing back these drawing objects, the display shifts to a state in which playback of the character or character string is complete. Compared to a case where the drawing object is played back at an actual playback speed, the playback time can be shortened.

<7. Arrangement of Playback Window>

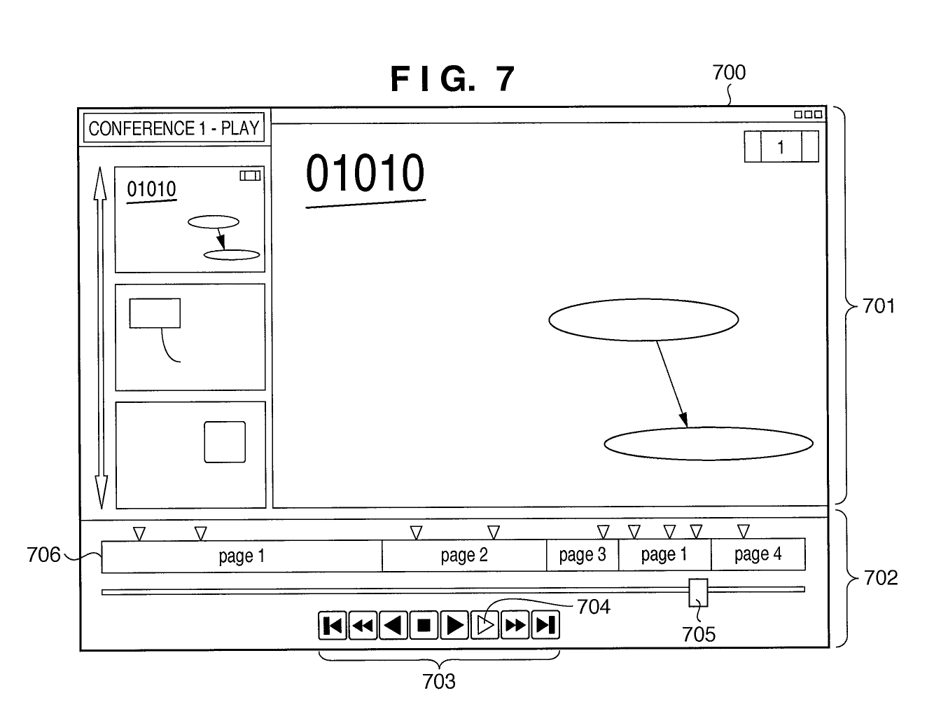

FIG. 7 is a view showing an example of a playback window 700 which plays back the drawn contents of the drawing area 302 during a conference based on the operation information table 221, drawing object information table 222, and playback method setting table 223 in the conferencing system 100. FIG. 7 shows an example of a UI in the playback mode of the electronic whiteboard application 210.

As shown in FIG. 7, a playback result display area 701 is displayed on the upper side of the playback window 700, and a playback operation area 702 is displayed on its lower side.

Various operation buttons 703 are used to control the playback method. The operation buttons 703 include buttons for changing the playback speed such as fast-forward and rewind, in addition to those for normal playback and stop. The operation buttons 703 include a playback button 704 to perform playback for shortening the playback time.

A slider 705 indicates the playback point during playback. The user can change the playback point by dragging the slider 705. A page transition 706 corresponds to the page number in the operation information table 221. In FIG. 7, the page transition 706 represents that the page switches to pages 1, 2, 3, 4, 3, 2, 1, 3, and 4 sequentially from the start of a conference, and page 1 is currently played back.

<8. Sequence of Overall Processing in Conferencing System 100>

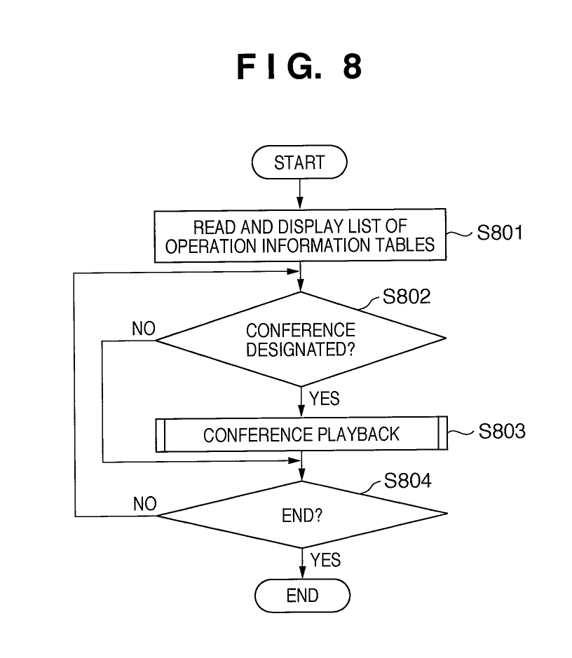

FIG. 8 is a flowchart showing the sequence of overall processing for playing back a conference in the playback mode of the electronic whiteboard application 210 of the conferencing system 100.

In step S801, initialization necessary for the operation of the electronic whiteboard application 210 is performed, and a list of operation information tables is read and displayed.

In step S802, a conference, playback of which is to start, is designated. The conference designation method is arbitrary. For example, the user may directly designate a conference from the list of operation information tables displayed in step S801, or designate a conference after searching for it under a predetermined search condition.

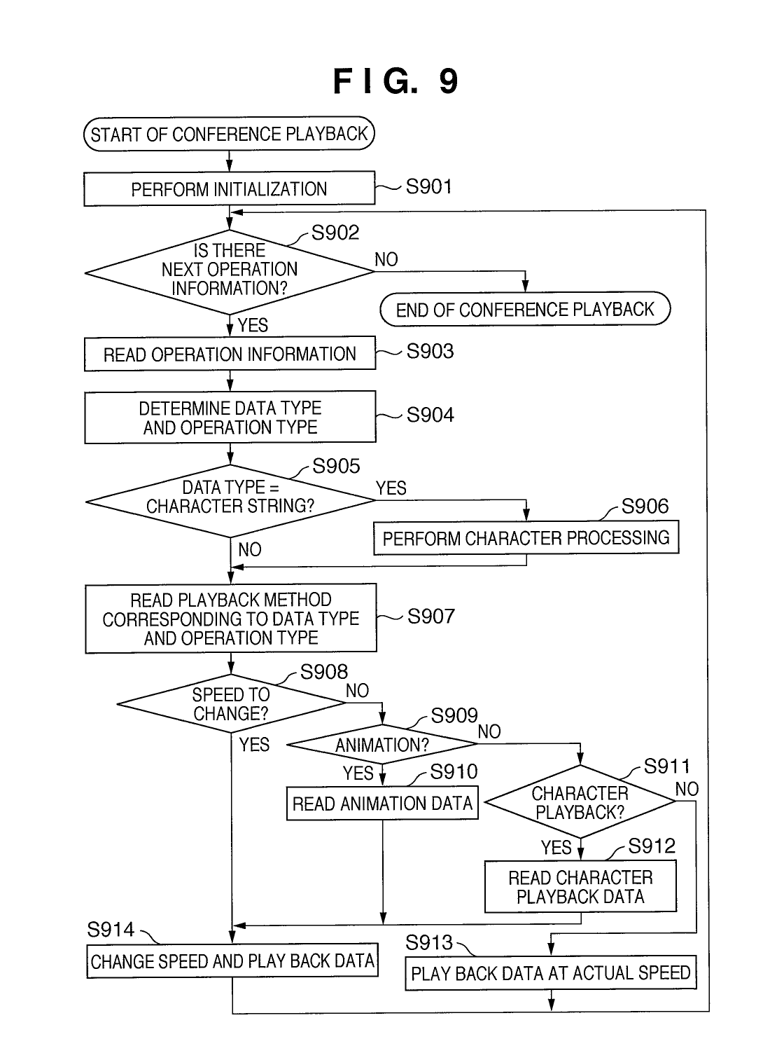

In step S803, the conference is played back based on operation information recorded in the operation information table designated in step S802. The detailed sequence of conference playback processing based on operation information will be explained with reference to FIG. 9.

In step S804, it is determined whether to end the electronic whiteboard application 210. If NO in step S804, the process returns to step S802 to play back a conference again based on another operation information table.

<9. Sequence of Conference Playback Processing>

FIG. 9 is a flowchart showing the sequence of conference playback processing executed based on operation information of a designated operation information table.

In step S901, initialization processing necessary to execute conference playback processing is performed to, for example, load a designated operation information table, and a corresponding drawing object information table and playback method setting table. In the conference playback processing, a conference is played back by reading out pieces of operation information in the operation information table in the order of operation start time.

In step S902, it is determined whether there is operation information at the next operation start time. If conference playback processing based on operation information stored at the bottom line of the operation information table is complete, and it is determined that there is no operation information at the next operation start time, the conference playback processing ends.

If it is determined that there is operation information at the next operation start time, the process advances to step S903 (first acquisition step) to read out the operation information. If there is a corresponding drawing object, it is read out from the drawing object information table.

In step S904, the operation information read out in step S903, and the data type and operation type of corresponding drawing object are determined.

In step S905, it is determined whether the data type determined in step S904 represents a character or character string. If it is determined in step S905 that the data type represents a character string, the process advances to step S906.

In step S906, character processing is performed. The character processing includes character extraction processing to extract a stroke forming a character or character string from one or more strokes drawn in the drawing area 302, and character recognition processing to recognize a character from the extracted stroke. One or more strokes recognized by the character processing to form a character are processed as one character data or character string data in subsequent steps.

As a character extraction method in the character extraction processing, for example, strokes close to each other in the drawing time are grouped, or strokes close to each other in the drawing position are grouped. These methods may also be combined. A character or character string is recognized from the extracted stroke group. Even after character recognition, the character string of the most probable character combination is calculated and separated from a plurality of recognized candidate characters by using a word dictionary, semantic dictionary, or the like, thereby achieving higher-precision character processing.

In the first embodiment, character processing is dynamically performed in conference playback processing, but the present invention is not limited to this. Character processing may also be executed in advance to save character string data during a conference, at the end of the conference, when saving drawn contents in the HDD 204, or when activating the playback mode of the electronic whiteboard application 210.

If it is determined in step S905 that the data type does not represent a character string, or if the character processing in step S906 is complete, the process advances to step S907.

In step S907 (second acquisition step), a playback method corresponding to the data type and operation type determined in step S904 is read out from the playback method setting table.

In step S908, it is determined whether the playback method read out in step S907 requires change of the speed. The playback method requiring change of the speed includes playback methods “fast” and “slow” among playback methods set in the playback method setting table.

If it is determined in step S908 that the playback method requires change of the speed, the process advances to step S914 to play back drawn contents by the playback method “fast” or “slow” based on the operation information read out in step S903.

If it is determined in step S908 that the playback method does not require change of the speed, the process advances to step S909 to determine whether the playback method read out in step S907 is “animation”. If it is determined in step S909 that the playback method is “animation”, the process advances to step S910 to read corresponding animation data, and then to step S914. In this case, drawn contents are played back in accordance with the read animation data in step S914.

If it is determined in step S909 that the playback method is not “animation”, the process advances to step S911 to determine whether the playback method read out in step S907 is “character playback”.

If it is determined in step S911 that the playback method is “character playback”, the process advances to step S912 to read character data or character string data obtained by performing character processing in step S906. Then, the process advances to step S914. In this case, the read character data or character string data are simultaneously played back in step S914.

If it is determined in step S911 that the playback method is not “character playback”, the process advances to step S913. In step S913, real-time playback is performed.

<10. Example of Conference Playback Processing>

A concrete example of the conference playback processing described with reference to FIGS. 8 and 9 will be explained with reference to FIG. 7.

In FIG. 7, a drawing object group “01010” is formed from five strokes in accordance with the drawing object information table of FIG. 5. If no character processing is done, each stroke is played back at an actual speed. According to the first embodiment, however, the character processing (step S906) is done to process “01010” as one character string.

According to the playback method setting table in FIG. 6, a corresponding playback method is “character playback—generate”, so “01010” is read and played back as character string data. In “character playback—generate”, character string data is played back at once. Hence, the five strokes are simultaneously played back.

Note that character string data is desirably played back by taking a time period enough to allow the user to recognize that the character string has been drawn. In this example, character string data is played back by taking a playback time as long as that taken to draw a figure by one stroke.

However, the character string data playback time may be shortened or prolonged in accordance with the length or complexity of the character string. If one drawing is complete within a predetermined time, the user may not be able to recognize the drawing. To prevent this, the playback time of one drawing may also be prolonged to a predetermined playback time to play back character string data, or a predetermined animation may also be played back. If one drawing is not complete within a predetermined time, the playback time of one drawing may also be shortened to a predetermined time to play back character string data, or a predetermined animation may also be played back.

Operation information next to the character string data “01010” is one associated with a drawing object of the object ID=6 in the operation information table of FIG. 4, and the operation type of drawing object is “generate”. Thus, corresponding drawing object data is read from the drawing object information table of FIG. 5. Since the data type for the object ID=6 is a figure, the playback method of the drawing object is “slow” in the playback method setting table of FIG. 6. The drawing object of the object ID=6 is played back at a speed slower than an actual speed.

Erase of a straight line as the next operation information is also processed by the same procedures. Further, generation corresponding to the object ID=7 as the next operation information is also processed by the same procedures.

Operation information next to generation corresponding to the object ID=7 is page switching in the operation information table of FIG. 4. A playback method for the data type=page and the operation type=switching is “animation 3” in FIG. 6, so animation data of animation 3 is read and played back.

As is apparent from the above description, in the conferencing system according to the first embodiment, when the drawn contents in the drawing area change, the changed contents are recorded in the operation information table. When the change of the drawn contents is a change of each drawing object in the drawing area, the changed contents are also recorded in the drawing object information table. At this time, the changed contents are recorded in correspondence with the data type and operation type. The drawn contents can be played back based on a playback method set for each data type and operation type.

For example, in the page switching operation, the entire screen is instantaneously switched. Considering this, it can be set to display an animation. The present invention can solve the conventional problem that it is difficult to recognize the page switching operation. The present invention can also solve the conventional problem that playback of a character input by handwriting strokes one by one takes a long time.

That is, playback which allows the user to easily grasp playback contents can be achieved by a simple method while shortening the playback time.

### Second Embodiment

In the first embodiment, recording in the operation information table 221 and drawing object information table 222, and playback of drawn contents are executed in the personal computer 120 connected to the rear-projection display 110. However, the present invention is not limited to this. For example, a device which records an operation information table and drawing object information table, and a device which plays back drawn contents may also be separately arranged via a network. A display control apparatus according to the second embodiment will be explained. Only differences from the first embodiment will be described.

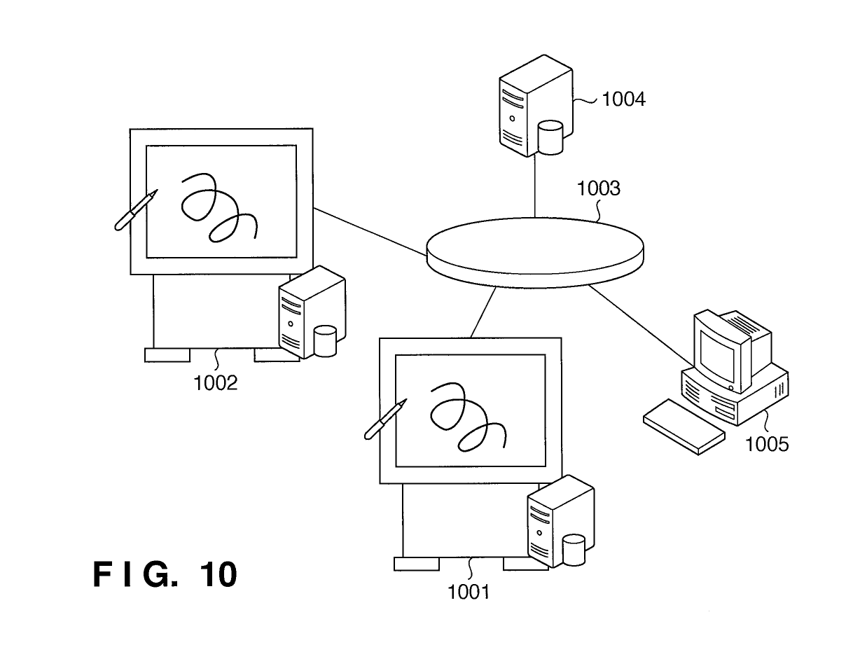

FIG. 10 is a view showing the overall configuration of a conferencing system (display control system) using the display control apparatus according to the second embodiment. In FIG. 10, each of conferencing systems 1001 and 1002 includes a rear-projection display, personal computer, and digitizer pen, and has the same configuration as that shown in FIG. 1.

A network 1003 is, for example, the Internet. A conference server 1004 stores operation information tables and drawing object information tables received from the conferencing systems 1001 and 1002 at respective locations. A personal computer 1005 functions as a display control apparatus.

Conferences are held in the conferencing systems 1001 and 1002 at the respective locations. Operation information tables and drawing object information tables recorded in the conferencing systems 1001 and 1002 are stored in the conference server 1004 via the network interfaces of the respective conferencing systems and the network 1003.

Drawn contents can be played back on devices, such as the conferencing systems 1001 and 1002 and personal computer 1005, which are connectable to the conference server 1004 via the network 1003. These devices have a function of executing the playback mode of the electronic whiteboard application, and a playback method setting table.

As described above, according to the second embodiment, when playing back drawn contents using operation information recorded in the conferencing system including a remote conference, playback which allows the user to easily grasp contents can be achieved while shortening the playback time.

### Other Embodiments

The present invention may be applied to a system including a plurality of devices (e.g., a host computer, interface device, reader, and printer) or an apparatus (e.g., a copying machine or facsimile apparatus) formed by a single device.

The object of the present invention is also achieved by supplying a recording medium which records software program codes for implementing the functions of the above-described embodiments to a system or apparatus. In this case, these functions are achieved by reading out and executing the program codes recorded on the recording medium by the computer (or the CPU or MPU) of the system or apparatus. In this case, the recoding medium which records the program codes constitutes the present invention.

The recoding medium for supplying the program codes includes a Floppy® disk, hard disk, optical disk, magnetooptical disk, CD-ROM, CD-R, magnetic tape, nonvolatile memory card, and ROM.

The present invention is not limited to a case where the functions of the above-described embodiments are implemented when the computer executes the readout program codes. Also, the present invention includes a case where an OS (Operating System) or the like running on the computer performs some or all of actual processes based on the instructions of the program codes and thereby implements the functions of the above-described embodiments.

Furthermore, the present invention includes a case where the functions of the above-described embodiments are implemented after the program codes read out from the recording medium are written in the memory of a function expansion board inserted into the computer or the memory of a function expansion unit connected to the computer. That is, the present invention also includes a case where after the program codes are written in the memory, the CPU of the function expansion board or function expansion unit performs some or all of actual processes based on the instructions of the program codes and thereby implements the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-165310 filed on Jun. 22, 2007, which is hereby incorporated by reference herein in its entirety.

What is claimed is:

1. A display control method in a display control apparatus connected to a display, the method comprising:
a first acquisition step of acquiring information on changed contents from a recording device which is connected to the display and records changed contents when drawn contents change in a drawing area on the display;
a second acquisition step of acquiring, from a playback method setting table set in correspondence with the changed contents, a playback method for playing back drawn contents on the display by using the information on changed contents acquired in the first acquisition step; and
a playback step of playing back the drawing contents on the display by using the information on changed contents acquired in the first acquisition step on the basis of the playback method acquired in the second acquisition step.

2. The method according to claim 1, wherein the information on changed contents includes an operation information table which sequentially records pieces of operation information on user operations that change drawn contents in the drawing area, and a drawing object information table which sequentially records pieces of information on objects in the drawing area that have changed upon the user operations.

3. The method according to claim 2, wherein the playback method set in the playback method setting table includes a playback method of increasing or decreasing a playback speed when playing back drawn contents on the display.

4. The method according to claim 3, wherein the playback method setting table sets a playback method of increasing the playback speed for an operation taking not less than a predetermined operation time among user operations which change drawn contents in the drawing area.

5. The method according to claim 3, wherein the playback method setting table sets a playback method of decreasing the playback speed for an operation taking not more than a predetermined operation time among user operations which change drawn contents in the drawing area.

6. The method according to claim 2, wherein the playback method set in the playback method setting table includes a playback method of playing back predetermined animation data on the display.

7. The method according to claim 6, wherein the playback method setting table sets a playback method of playing back the predetermined animation data on the display for a page operation to a page which forms the drawing area, among user operations which change drawn contents in the drawing area.

8. The method according to claim 2, wherein the playback method set in the playback method setting table includes a playback method of, when an object changed in the drawing area upon the user operation is an object which forms a character or character string, playing back only the changed character or character string on the display for a predetermined time.

9. A display control apparatus connected to a display, the apparatus comprising:
a first acquisition unit configured to acquire information on changed contents from a recording device which is connected to the display and records changed contents when drawn contents change in a drawing area on the display;
a second acquisition unit configured to acquire, from a playback method setting table set in correspondence with the changed contents, a playback method for playing back drawn contents on the display by using the information on changed contents acquired by said first acquisition unit; and
a playback unit configured to play back the drawn contents on the display by using the information on changed contents acquired by said first acquisition unit on the basis of the playback method acquired by said second acquisition unit.

10. A computer-readable storage medium storing a control program for causing a computer to execute a display control method defined in claim 1.
